(19) United States
(12) Patent Application Publication
(10) Pub. No.: US 2025/0384595 A1
(43) Pub. Date: Dec. 18, 2025

(54) METHOD AND ELECTRONIC DEVICE FOR OBTAINING LANDSCAPE PAINTING GENERATION MODEL AND COMPUTER-READABLE STORAGE

(71) Applicant: UBTECH ROBOTICS CORP LTD, Shenzhen (CN)

(72) Inventors: Yusheng ZENG, Shenzhen (CN); Pei DONG, Shenzhen (CN); Jianxin PANG, Shenzhen (CN); Xilai SONG, Shenzhen (CN)

(21) Appl. No.: 19/026,699

(22) Filed: Jan. 17, 2025

(30) Foreign Application Priority Data
Jun. 18, 2024 (CN) 202410789693.0

(51) Int. Cl. G06T 11/00; G06N 3/094

(52) U.S. Cl. CPC G06T 11/00; G06N 3/094

(57) ABSTRACT

A method includes: based on a generative adversarial network, constructing and training an initial network; constructing a teacher network and a student network using the initial network; inputting landscape painting training samples into the teacher network and the student network for feature extraction to obtain multiple first predicted feature maps and multiple intermediate feature maps output by the student network, and multiple second predicted feature maps and multiple interactive feature maps output by the teacher network; wherein the interactive feature maps are obtained by inputting the intermediate feature maps extracted by the student network at different stages into the teacher network; based on feature constraints between the first predicted feature maps and the second predicted feature maps, and feature constraints between the second predicted feature maps and each of the interactive feature maps, calculating training losses; and adjusting parameters of the student network based on the training losses.

### CROSS REFERENCE TO RELATED APPLICATIONS

This application claims priority to Chinese Patent Application No. CN 202410789693.0, filed Jun. 18, 2024, which is hereby incorporated by reference herein as if set forth in its entirety.

### TECHNICAL FIELD

The present disclosure generally relates to image generation technologies, and in particular relates to a method and electronic device for obtaining a landscape painting generation model and computer-readable storage medium.

### BACKGROUND

Landscape painting generation refers to the process of generating corresponding landscape paintings in response to the input of simple stroke drawings (also referred to as “simple drawings”) from a user using generative techniques, as shown in FIG. 1. The core technology route is style transfer, which includes generation techniques such as CycleGAN for unpaired data and Pix2pix for paired data. However, the unpaired data-based technique tends to generate unstable results, often leading to artifacts and noise. On the other hand, although the Pix2pix technique can achieve relatively stable generation results, it cannot decouple style and content, and its model requires significant memory usage with inference speed that needs improvement.

Therefore, there is a need to provide a method for obtaining a landscape painting generation model to overcome the above-mentioned problems.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 shows a schematic diagram of generating a landscape painting from a simple stroke drawing.

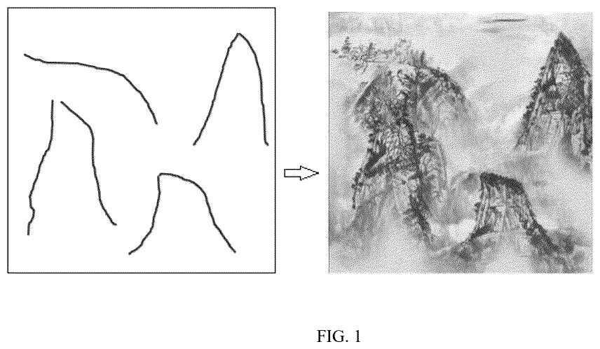

FIG. 2 is a schematic block diagram of an electronic device according to one embodiment.

FIG. 3 is an exemplary flowchart of a method for obtaining a landscape painting generation model according to one embodiment.

FIG. 4 shows a schematic diagram of constructing the initial landscape painting network based on a generative adversarial network.

FIG. 5 shows a schematic diagram of the training process of the initial landscape painting network.

FIG. 6 shows a schematic diagram of training the landscape painting generation model based on an interactive distillation network.

FIG. 7 is a schematic block diagram of a landscape painting generation model acquisition device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

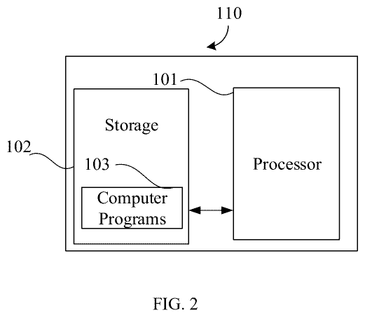

FIG. 2 shows a schematic block diagram of an electric device 110 according to one embodiment. The electronic device 110 can be, but is not limited to, a desktop computer, an educational or entertainment robot, a portable electronic device such as a tablet computer, smartphone, etc. The specific form is not limited.

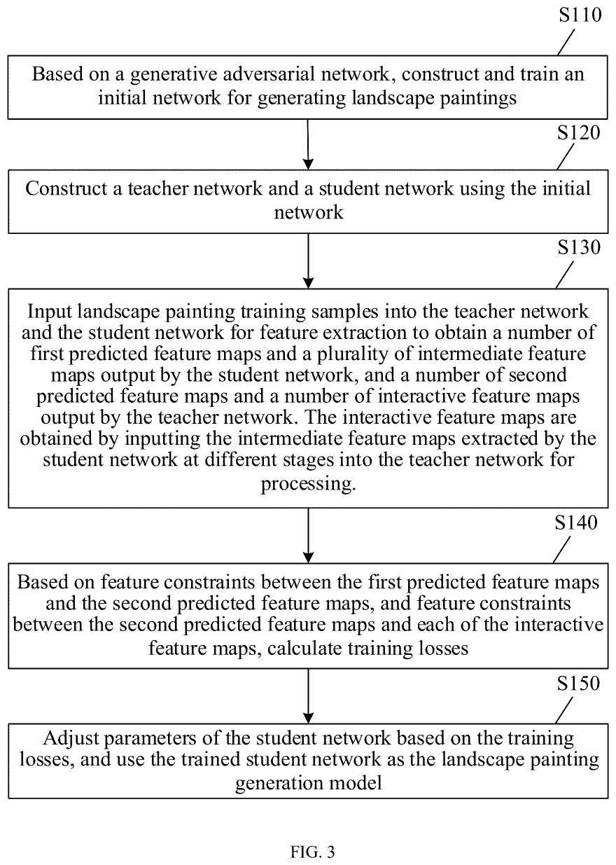

In one embodiment, the electronic device 110 may include a processor 101, a storage 102, and one or more executable computer programs 103 that are stored in the storage 102. The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of a method for obtaining a landscape painting generation model, such as steps S110 to S150 in FIG. 3 are implemented.

The processor 101 may be an integrated circuit chip with signal processing capability. The processor 101 may be a central processing unit (CPU), a graphics processing unit (GPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

It should be noted that, due to the lightweight design of the trained landscape painting generation model, during the deployment phase, some deployment strategies can be employed to achieve efficient deployment that allows for high concurrency.

For example, in one embodiment, the processor includes at least one CPU. In this case, when the electronic device deploys the trained landscape painting generation model, the model can be deployed to the CPU and inference engine acceleration can be performed using the Openvino tool. Openvino, or open visual inference and neural network optimization, is an open-source tool for visual inference and neural network optimization, which uses an inference engine to deploy deep learning models to hardware.

For instance, in another embodiment, the processor may include at least one GPU. In this case, when the electronic device deploys the trained landscape painting generation model, the model can be deployed to the GPU and inference engine acceleration can be performed using the TensorRT tool. Similarly, TensorRT is a set of SDK tools developed by NVIDIA Corporation for high-performance inference of deep learning models on GPUs. After optimization with TensorRT, an optimized inference engine is obtained, and the deep learning model can be serialized to hardware.

Alternatively, in another embodiment, the processor may include both at least one GPU and at least one CPU. For example, for electronic devices with multi-core CPUs and graphics cards, multiple GPUs and/or CPUs can be used simultaneously to execute the landscape painting generation model, thereby improving resource utilization and maximizing the performance of the processors.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the electronic device 110, such as a hard disk or a memory. The storage 102 may also be an external storage device of the electronic device 110, such as a plug-in hard disk, a smart memory card (SMC), and a secure digital (SD) card, or any suitable flash cards. Furthermore, the storage 102 may also include both an internal storage unit and an external storage device. The storage 102 is to store computer programs, other programs, and data required by the electronic device 110. The storage 102 can also be used to temporarily store data that have been output or is about to be output.

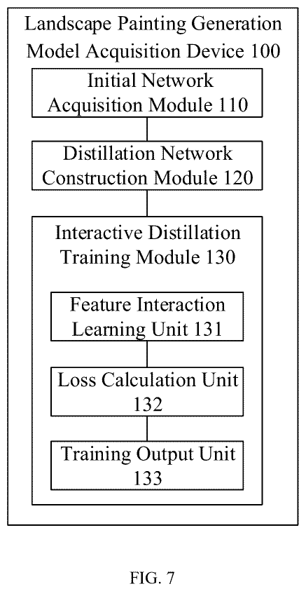

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the electronic device 110. For example, the one or more computer programs 103 may be divided into an initial network acquisition module 110, a distillation network construction module 120 and an interactive distillation training module 130 as shown in FIG. 7.

It should be noted that the block diagram shown in FIG. 2 is only an example of the electronic device 110. The electronic device 110 may include more or fewer components than what is shown in FIG. 2, or have a different configuration than what is shown in FIG. 2. Each component shown in FIG. 2 may be implemented in hardware, software, or a combination thereof.

FIG. 3 is an exemplary flowchart of a method for obtaining a landscape painting generation model according to one embodiment. As an example, but not a limitation, the method can be implemented by the electronic device 110. The method may include the following steps.

Step S110: Based on a generative adversarial network, construct and train an initial network for generating landscape paintings.

A generative adversarial network (GAN) includes a generator and a discriminator, which are trained through an adversarial process. Ultimately, the generator produces fake images that increasingly resemble real images, while the discriminator becomes more adept at distinguishing fake images that closely resemble real ones. In one embodiment, a StyleGAN based on style transfer will be used to obtain a stable landscape painting generation initial network. Specifically, the trained generator in StyleGAN is used to generate an image from the input simple stroke drawing (also referred to as “simple drawing”) that better matches the content and style of a target landscape painting. The discriminator is used to assess the generation effect of the generated image. It is important to note that, because random noise input into the generator can introduce diversity, and since style transfer is required in the present disclosure, random noise is not required.

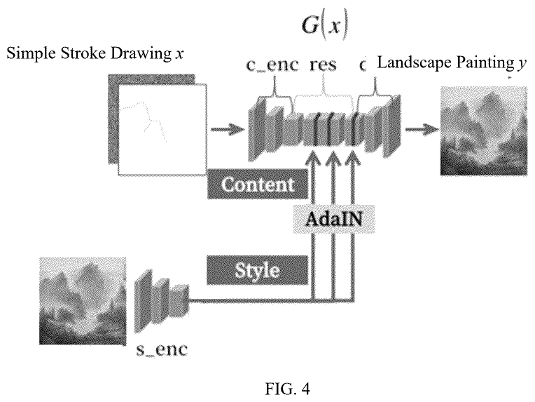

In one embodiment, the generator in StyleGAN includes a content encoding module, a feature combination module, and a content decoding module connected to each other sequentially, as well as a style feature encoding module connected to the feature combination module. In one embodiment, step S110 may include the following steps: a number of acquired simple stroke drawings are input into the generator shown in FIG. 4, where the content encoding module (i.e., c_enc in FIG. 4) performs content feature extraction, resulting in a number of content feature maps. Meanwhile, a number of target landscape paintings are processed by the style feature encoding module (i.e., s_enc in FIG. 4) to extract style features, obtaining a number of style feature maps. Subsequently, the style feature maps and content feature maps are fused through the feature combination module (i.e., res in FIG. 4), and then processed by the content decoding module (i.e., dec in FIG. 4), generating a number of landscape painting images corresponding to the simple stroke drawings. It should be noted that the output of the style feature encoding module is first processed through adaptive instance normalization (AdaIN) before being input into the feature combination module for fusion.

It can be understood that in the present disclosure, by using the content encoding module and style feature encoding to separately perform feature extraction, and then using AdaIN to integrate the extracted style features into the process of generating the landscape paintings, the decoupling of style and content can be achieved. Moreover, since AdaIN only needs to adjust the mean and variance of the content images to match the mean and variance of the style images, it allows for efficient style transfer.

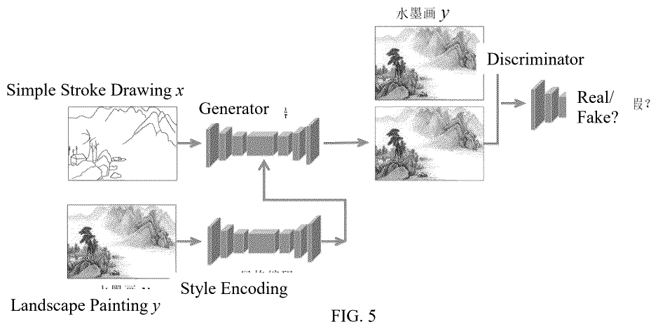

Next, the target landscape paintings and the generated landscape painting images output by the generator are input into the discriminator for evaluation, as shown in FIG. 5, to obtain the evaluation result. Then, based on the target landscape paintings, the generated landscape painting images, and the evaluation result, the learning loss is computed using the constructed loss function. The learning loss is then used for gradient backpropagation to adjust the parameters of the GAN until the loss function converges, stopping the training. The trained GAN is then used as the initial network for generating landscape paintings.

In one embodiment, the loss function of the GAN is used to compute two parts of the loss: the adversarial loss and the cycle consistency loss. It can be understood that the adversarial loss is used to constrain the adversarial relationship between the generator and the discriminator, while the cycle consistency loss is used to ensure that the original input simple stroke drawings and the reconstructed input remain as consistent as possible.

For example, the adversarial loss can be constructed based on loss functions such as cross-entropy. For instance, it can be calculated using the following objective function: L_{GAN} (G, D_{Y}, X, Y)=E_{y˜Pdata (y)} [logD_{Y} (y)]+E_{x˜Pdata (x)} [log (1−D_{Y} (G (x)))], where L_{GAN} represents the adversarial loss, G and Dy represent the generator and discriminator, respectively; X and Y represent the simple stroke drawings and target landscape paintings, respectively; D_{Y} (y) represents the discriminator's discrimination result on the target landscape paintings; D_{Y} (G (x)) represents the discriminator's discrimination result on the generated images G (x); E_{y˜Pdata (y)} represents the expectation when y belongs to the real data P_{data(y)}, and E_{x˜Pdata (x)} represents the expectation when x belongs to the real data P_{data(x)}.

For example, the cycle consistency loss can be computed using the following objective function: L_{cyc} (G, F)=E_{x˜Pdata (x)} [∥F (G(x)−x)∥₁], where L_{CYC} represents the cycle consistency loss; F(G(x)) represents the reconstructed result of the generated images G(x); ∥*∥₁ denotes the L1 norm; and F can be considered as the reconstructor that reconstructs the simple stroke drawings X based on the generated images G(x).

Step S120: Construct a teacher network and a student network using the initial network.

For example, using the trained initial network, a teacher network and a student network are constructed. Furthermore, the teacher network can be divided into four stages, where each stage corresponds to one of the four modules in the generator. For instance, the content encoding module corresponds to the first stage, the style feature encoding module and the feature combination module correspond to the second and third stages, and the content decoding module corresponds to the fourth stage. It is important to note that the stage division of the student network is the same as that of the teacher network, but the structure of the student network is simplified. Specifically, each module corresponding to each stage in the student network undergoes block pruning and channel pruning, thus achieving a lightweight design to ensure effective speedup.

Step S130: Input landscape painting training samples into the teacher network and the student network for feature extraction to obtain a number of first predicted feature maps and a plurality of intermediate feature maps output by the student network, and a number of second predicted feature maps and a number of interactive feature maps output by the teacher network. The interactive feature maps are obtained by inputting the intermediate feature maps extracted by the student network at different stages into the teacher network for processing.

For example, by inputting the same landscape painting training samples into both the teacher network and the student network for processing, the predicted feature maps (i.e., the first and second predicted feature maps) output by the teacher network and the student network can be obtained. Additionally, since the structure of the student network has been pruned, and to ensure that the student network's accuracy is as close as possible to that of the teacher network, an interactive distillation design is adopted. Specifically, the intermediate feature maps extracted by the student network at different stages are input into the teacher network for processing, thereby obtaining the corresponding interactive feature maps output by the teacher network.

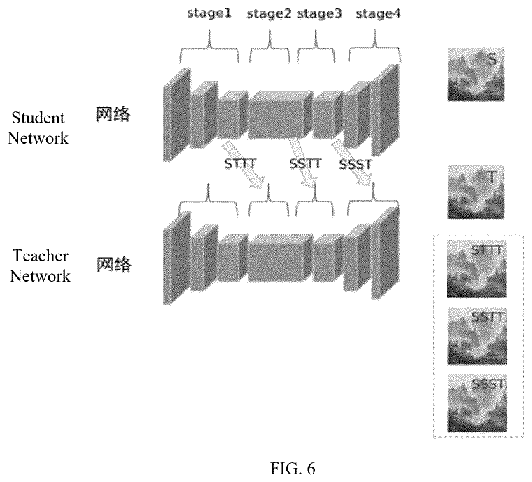

For example, in one embodiment, as shown in FIG. 6, the first intermediate feature map extracted by the first stage (stage 1) of the student network is used as the input to the second stage (stage 2) of the teacher network. The second intermediate feature map extracted by the second stage (stage 2) of the student network is used as the input to the third stage (stage 3) of the teacher network, and the third intermediate feature map extracted by the third stage (stage 3) of the student network is used as the input to the fourth stage (stage 4) of the teacher network. Then, after the teacher network performs further feature extraction on the corresponding intermediate feature maps, the corresponding first interactive feature map (i.e., the STTT feature map in FIG. 6), second interactive feature map (i.e., the SSTT feature map in FIG. 6), and third interactive feature map (i.e., the SSST feature map in FIG. 6) are output. In other words, STTT refers to the prediction result obtained by processing the first intermediate feature map through stages 2-4 of the teacher network; SSTT refers to the prediction result obtained by processing the second intermediate feature map through stages 3-4 of the teacher network; and SSST refers to the prediction result obtained by processing the third intermediate feature map through stage 4 of the teacher network.

Step S140: Based on feature constraints between the first predicted feature maps and the second predicted feature maps, and feature constraints between the second predicted feature maps and each of the interactive feature maps, calculate training losses.

For example, in one embodiment, the feature constraints mentioned above mainly include four aspects: structural similarity constraint, content consistency constraint, style consistency constraint, and regularization smoothness constraint, each of which is associated with a loss function for calculating the corresponding constraint loss value. It can be understood that the two feature maps used for calculation can refer to the first prediction feature map and the second prediction feature map, or they can refer to the second prediction feature map and any one of the interactive feature maps.

The loss function for the structural similarity constraint is constructed based on the similarity in brightness, contrast, and structure between the two feature maps. For example, the brightness, contrast, and structure of the feature maps can be correspondingly represented by the image mean, standard deviation, and covariance, respectively.

For example, let the two feature maps used for calculation be denoted as x and y. The structural similarity constraint can be calculated using the following equation:

$$SSIM ( x , y ) = \frac{( 2 * {μ}_{x} * {μ}_{y} + C 1 ) * ( 2 * {σ}_{x y} + C 2 )}{( {μ}_{x}^{2} + {μ}_{y}^{2} + C 1 ) * ( {σ}_{x}^{2} + {σ}_{y}^{2} + C 2 )} ,$$

where SSIM(x, y) represents the structural similarity constraint loss between the two feature maps x and y; μₓ and μ_{y} represent the mean values of feature maps x and y, respectively; σ_{xy} represents the covariance between feature maps x and y, and σₓ² and σ_{y}² represent the variance of feature maps x and y, respectively; C1 and C2 are preset constants used to avoid division by zero.

In one embodiment, the loss function for content consistency constraint is constructed based on the content similarity between the two feature maps. For example, an L1 loss function can be used, which is calculated by the following equation: L1_Loss(x, y)=∥x−y∥, where L1_Loss represents the content consistency constraint loss between the two feature maps x and y.

The style consistency constraint loss function is constructed based on the difference in channel correlations between the two feature maps. It can be understood that the style consistency constraint mainly aims to enforce the difference in style features between the two feature maps, such as color, texture, common patterns, etc.

In one embodiment, the difference between the features predicted using a pre-trained VGG16 model can be calculated using a Gram matrix. The Gram matrix reflects the correlation between the channels of the predicted feature maps, and the channel correlation's influence on the style can be understood as follows: some channels may predict mountains, while other channels predict water. By establishing channel correlations, what initially seems to be unrelated objects (mountains and water) can form the stylistic foundation of a landscape painting. For example, when described by a equation, it can be represented as follows:

$$PerceptualLoss ( x , y ) = ‖ {G}_{j}^{φ} ( x ) - {G}_{j}^{φ} ( y ) ‖ ,$$

where PerceptualLoss represents the style consistency constraint loss between two feature maps x and y, G represents the Gram matrix, φ represents the features predicted using the pre-trained VGG16 model, and j refers to the j-th stage feature.

The regularization smoothness constraint loss function is constructed based on the difference in gradient variations between two feature maps. It can be understood that this regularization smoothness constraint helps maintain the smoothness of images by constraining the gradients. For example, if described by an equation, it would be: TV_Loss(x, y)=∥sum_diff(x)−sum_diff(y)∥, where TV_Loss(x, y) represents the total variation smoothness constraint loss between two feature maps x and y, sum_diff(x) represents the sum of the gradients of feature map x in the x and y directions, while sum_diff(y) represents the sum of the gradients of feature map y in the x and y directions.

Based on the four feature constraints and corresponding loss functions mentioned above, the interactive distillation loss Loss_{dist} (x, y) between each pair of feature maps can be calculated according to the following equation: Loss_{dist} (x,y)=SSIM(x, y)+L1_Loss(x,y)+PerceptualLoss(x, y)+TV_Loss(x, y).

In one embodiment, the training loss mentioned above includes the first-type loss between the first predicted feature map and the second predicted feature map, and the second-type loss between the second predicted feature map and each of the interactive feature maps. It can be understood that the number of second-type losses is equal to the number of interactive feature maps. For instance, with three interactive feature maps, there are three second-type losses, which are the losses between the second predicted feature map and the first, second, and third interactive feature maps, respectively.

For example, the total training loss can be the sum of the first-type loss and all the second-type losses. For the first-type loss and each second-type loss, they can be calculated separately as described above. Finally, summing the individual loss values gives the total loss for this training session, denoted as Total_Loss. If expressed in an equation, it is as follows:

$${Total}_{L o s s} = {Loss}_{d i s t} ( S , T ) + {Loss}_{dist} ( STTT , T ) + {Loss}_{d i s t} ( STTT , T ) + {Loss}_{d i s t} ( STTT , T ) .$$

In another embodiment, corresponding weights can be assigned to the first-type loss and each of the second-type losses, and then the weighted sum can be used as the total training loss described above. This is not intended to be limiting.

Step S150: Adjust parameters of the student network based on the training losses, and use the trained student network as the landscape painting generation model.

By using the training loss for gradient backpropagation, the student network continues training until the preset conditions are met, and the trained student network is then used as the landscape painting generation model.

The preset conditions are used to determine when to stop training. For example, these conditions may include, but are not limited to, the total training loss being smaller than a preset threshold, reaching a preset number of iterations, or satisfying both the total loss value and the number of iterations. The specific conditions are not limited here.

The landscape painting generation model obtained through the method described above adopts a lightweight design. At the same time, by using the interactive knowledge distillation method, it ensures that the lightweight model maintains a certain level of accuracy. On one hand, this effectively improves inference speed and reduces memory usage. On the other hand, it provides a solid foundation for deployment in environmental conditions (such as servers) and can also enhance concurrency, among other benefits.

The present disclosure further proposes a landscape painting generation method. Exemplarily, the landscape painting generation method includes: inputting a simple stoke drawing into a trained landscape painting generation model to generate the corresponding landscape painting (e.g., a Chinese landscape painting); where the landscape painting generation model is obtained using the method described above. It can be understood that the simple stroke drawing can be input by a user on the display interface of the electronic device, or obtained from other devices. This is not limited here.

The landscape paintings generated based on the landscape painting generation model exhibit a variety of unique features and can showcase diverse visual styles, especially when depicting seasonal changes. For example, in the generated landscape paintings, mountains can take various forms, from snow-capped peaks in winter to lush, tree-filled cliffs in summer. Lakes, rivers, and oceans are common elements in landscape paintings. The water in spring and summer is usually clear and bright, while in autumn and winter, it may appear still or frozen. Seasonal changes also affect the tone of the sky. Spring and autumn skies are often soft, with warm sunrises and sunsets. Winter skies are typically cold and overcast, sometimes featuring mist or snowflakes.

The landscape painting generation model can generate landscape paintings in a heavy brushstroke oil painting style, with smooth transitions in colors to highlight the intricate details of nature. Alternatively, the landscape painting generation model can generate watercolor effect, with gradient color transitions and soft, blended elements to depict natural scenery with a more fluid, delicate appearance.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

FIG. 7 shows a schematic block diagram of a landscape painting generation model acquisition device 100 according to one embodiment. In one embodiment, the landscape painting generation model acquisition device 100 may include an initial network acquisition module 110, a distillation network construction module 120 and an interactive distillation training module 130. The initial network acquisition module 110 is to, based on a generative adversarial network, construct and train an initial network for generating landscape paintings. The distillation network construction module 120 is to construct a teacher network and a student network using the initial network. The interactive distillation training module 130 includes a feature interaction learning unit 131, a loss calculation unit 132, and a training output unit 133. The feature interaction learning unit 131 is to input landscape painting training samples into the teacher network and the student network for feature extraction to obtain a number of first predicted feature maps and a plurality of intermediate feature maps output by the student network, and a number of second predicted feature maps and a number of interactive feature maps output by the teacher network. The interactive feature maps are obtained by inputting the intermediate feature maps extracted by the student network at different stages into the teacher network for processing. The loss calculation unit 132 is to, based on feature constraints between the first predicted feature maps and the second predicted feature maps, and feature constraints between the second predicted feature maps and each of the interactive feature maps, calculate training losses. The training output unit 133 is to adjust parameters of the student network based on the training losses, and use the trained student network as the landscape painting generation model.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for obtaining a landscape painting generation model, the method comprising:
based on a generative adversarial network, constructing and training an initial network for generating landscape paintings;
constructing a teacher network and a student network using the initial network;
inputting landscape painting training samples into the teacher network and the student network for feature extraction to obtain a plurality of first predicted feature maps and a plurality of intermediate feature maps output by the student network, and a plurality of second predicted feature maps and a plurality of interactive feature maps output by the teacher network; wherein the interactive feature maps are obtained by inputting the intermediate feature maps extracted by the student network at different stages into the teacher network for processing;
based on feature constraints between the first predicted feature maps and the second predicted feature maps, and feature constraints between the second predicted feature maps and each of the interactive feature maps, calculating training losses; and
adjusting parameters of the student network based on the training losses, and using a trained student network as the landscape painting generation model.

2. The method of claim 1, wherein the generative adversarial network comprises a generator and a discriminator, the generator comprises a content encoding module, a feature combination module, a style feature encoding module, and a content decoding module; constructing and training the initial network for generating landscape paintings based on the generative adversarial network comprises:
inputting acquired simple stroke drawings into the generator to process the simple stroke drawings using the content encoding module to obtain a plurality of content feature maps, and processing a plurality of target landscape paintings through the style feature encoding module to obtain a plurality of style feature maps; combining the style feature maps and the content feature maps through the feature combination module, and then processing the combined feature maps and content feature maps through the content decoding module to obtain a plurality of landscape painting images generated based on the simple stroke drawings; and processing the target landscape paintings and the landscape painting images using the discriminator to obtain a discrimination result; and
calculating learning losses based on the target landscape paintings, the landscape painting images and the discrimination result, adjusting parameters of the generative adversarial network based on the learning losses so as to use a trained generative adversarial network as the initial network for generating the landscape painting.

3. The method of claim 2, wherein the teacher network comprises four stages that correspond to the content encoding module, the feature combination module, the style feature encoding module, and the content decoding module in the generator, and modules corresponding to stages in the student network undergo block pruning and channel pruning.

4. The method of claim 1, wherein the teacher network and the student network both comprise four stages; inputting the intermediate feature maps extracted by the student network at different stages into the teacher network comprises:
using a first intermediate feature map extracted from a first stage of the student network as an input to a second stage of the teacher network; using a second intermediate feature map extracted from a second stage of the student network as an input to a third stage of the teacher network; and using a third intermediate feature map extracted from a third stage of the student network as an input to a fourth stage of the teacher network; and
obtaining a first interactive feature map, a second interactive feature map and a third interactive feature map by processing each of the intermediate feature maps using the teacher network.

5. The method of claim 1, wherein the training losses comprise first losses between the first predicted feature maps and the second predicted feature maps, and second losses between the second predicted feature maps and each of the interactive feature maps; and the training losses are a sum of the first losses and all of the second losses.

6. The method of claim 1, wherein the feature constraints comprise a structural similarity constraint, a content consistency constraint, a style consistency constraint, and a regularization smoothness constraint between two feature maps to be calculated, with each of the constraints having a corresponding loss function for calculating a constraint loss; and a loss between the two feature maps is a sum of the constraint losses.

7. The method of claim 6, wherein the loss function for the structural similarity constraint is constructed based on a similarity in brightness, contrast, and structure between the two feature maps; the loss function for the content consistency constraint is constructed based on a content similarity between the two feature maps; the loss function for the style consistency constraint is constructed based on a difference in channel correlation between the two feature maps; and the loss function for the regularization smoothness constraint is constructed based on a difference in gradient variations between the two feature maps.

8. An electronic device comprising:
one or more processors; and
a memory coupled to the one or more processors, the memory storing programs that, when executed by the one or more processors, cause performance of operations comprising:
based on a generative adversarial network, constructing and training an initial network for generating landscape paintings;
constructing a teacher network and a student network using the initial network;
inputting landscape painting training samples into the teacher network and the student network for feature extraction to obtain a plurality of first predicted feature maps and a plurality of intermediate feature maps output by the student network, and a plurality of second predicted feature maps and a plurality of interactive feature maps output by the teacher network; wherein the interactive feature maps are obtained by inputting the intermediate feature maps extracted by the student network at different stages into the teacher network for processing;
based on feature constraints between the first predicted feature maps and the second predicted feature maps, and feature constraints between the second predicted feature maps and each of the interactive feature maps, calculating training losses; and
adjusting parameters of the student network based on the training losses, and using a trained student network as a landscape painting generation model.

9. The electronic device of claim 8, wherein the generative adversarial network comprises a generator and a discriminator, the generator comprises a content encoding module, a feature combination module, a style feature encoding module, and a content decoding module;
constructing and training the initial network for generating landscape paintings based on the generative adversarial network comprises:
inputting acquired simple stroke drawings into the generator to process the simple stroke drawings using the content encoding module to obtain a plurality of content feature maps, and processing a plurality of target landscape paintings through the style feature encoding module to obtain a plurality of style feature maps; combining the style feature maps and the content feature maps through the feature combination module, and then processing the combined feature maps and content feature maps through the content decoding module to obtain a plurality of landscape painting images generated based on the simple stroke drawings; and processing the target landscape paintings and the landscape painting images using the discriminator to obtain a discrimination result; and
calculating learning losses based on the target landscape paintings, the landscape painting images and the discrimination result, adjusting parameters of the generative adversarial network based on the learning losses so as to use a trained generative adversarial network as the initial network for generating the landscape painting.

10. The electronic device of claim 9, wherein the teacher network comprises four stages that correspond to the content encoding module, the feature combination module, the style feature encoding module, and the content decoding module in the generator, and modules corresponding to stages in the student network undergo block pruning and channel pruning.

11. The electronic device of claim 8, wherein the teacher network and the student network both comprise four stages; inputting the intermediate feature maps extracted by the student network at different stages into the teacher network comprises:
using a first intermediate feature map extracted from a first stage of the student network as an input to a second stage of the teacher network; using a second intermediate feature map extracted from a second stage of the student network as an input to a third stage of the teacher network; and using a third intermediate feature map extracted from a third stage of the student network as an input to a fourth stage of the teacher network; and
obtaining a first interactive feature map, a second interactive feature map and a third interactive feature map by processing each of the intermediate feature maps using the teacher network.

12. The electronic device of claim 8, wherein the training losses comprise first losses between the first predicted feature maps and the second predicted feature maps, and second losses between the second predicted feature maps and each of the interactive feature maps; and the training losses are a sum of the first losses and all of the second losses.

13. The electronic device of claim 8, wherein the feature constraints comprise a structural similarity constraint, a content consistency constraint, a style consistency constraint, and a regularization smoothness constraint between two feature maps to be calculated, with each of the constraints having a corresponding loss function for calculating a constraint loss; and a loss between the two feature maps is a sum of the constraint losses.

14. The electronic device of claim 13, wherein the loss function for the structural similarity constraint is constructed based on a similarity in brightness, contrast, and structure between the two feature maps; the loss function for the content consistency constraint is constructed based on a content similarity between the two feature maps; the loss function for the style consistency constraint is constructed based on a difference in channel correlation between the two feature maps; and the loss function for the regularization smoothness constraint is constructed based on a difference in gradient variations between the two feature maps.

15. The electronic device of claim 8, wherein the one or more processors comprise a central processing unit and/or a graphics processing unit; the electronic device is configured to deploy the landscape painting generation model onto the graphics processing unit and accelerate an inference engine using a TensorRT tool; and/or deploy the landscape painting generation model onto the central processing unit and accelerate the inference engine using an Openvino tool.

16. A non-transitory computer-readable storage medium storing instructions that, when executed by at least one processor of a control device, cause the at least one processor to perform a method for obtaining a landscape painting generation model, the method comprising:
based on a generative adversarial network, constructing and training an initial network for generating landscape paintings;
constructing a teacher network and a student network using the initial network;
inputting landscape painting training samples into the teacher network and the student network for feature extraction to obtain a plurality of first predicted feature maps and a plurality of intermediate feature maps output by the student network, and a plurality of second predicted feature maps and a plurality of interactive feature maps output by the teacher network; wherein the interactive feature maps are obtained by inputting the intermediate feature maps extracted by the student network at different stages into the teacher network for processing;
based on feature constraints between the first predicted feature maps and the second predicted feature maps, and feature constraints between the second predicted feature maps and each of the interactive feature maps, calculating training losses; and
adjusting parameters of the student network based on the training losses, and using a trained student network as the landscape painting generation model.

17. The non-transitory computer-readable storage medium of claim 16, wherein the generative adversarial network comprises a generator and a discriminator, the generator comprises a content encoding module, a feature combination module, a style feature encoding module, and a content decoding module; constructing and training the initial network for generating landscape paintings based on the generative adversarial network comprises:
inputting acquired simple stroke drawings into the generator to process the simple stroke drawings using the content encoding module to obtain a plurality of content feature maps, and processing a plurality of target landscape paintings through the style feature encoding module to obtain a plurality of style feature maps; combining the style feature maps and the content feature maps through the feature combination module, and then processing the combined feature maps and content feature maps through the content decoding module to obtain a plurality of landscape painting images generated based on the simple stroke drawings; and processing the target landscape paintings and the landscape painting images using the discriminator to obtain a discrimination result; and
calculating learning losses based on the target landscape paintings, the landscape painting images and the discrimination result, adjusting parameters of the generative adversarial network based on the learning losses so as to use a trained generative adversarial network as the initial network for generating the landscape painting.

18. The non-transitory computer-readable storage medium of claim 17, wherein the teacher network comprises four stages that correspond to the content encoding module, the feature combination module, the style feature encoding module, and the content decoding module in the generator, and modules corresponding to stages in the student network undergo block pruning and channel pruning.

19. The non-transitory computer-readable storage medium of claim 16, wherein the teacher network and the student network both comprise four stages; inputting the intermediate feature maps extracted by the student network at different stages into the teacher network comprises:
using a first intermediate feature map extracted from a first stage of the student network as an input to a second stage of the teacher network; using a second intermediate feature map extracted from a second stage of the student network as an input to a third stage of the teacher network; and using a third intermediate feature map extracted from a third stage of the student network as an input to a fourth stage of the teacher network; and
obtaining a first interactive feature map, a second interactive feature map and a third interactive feature map by processing each of the intermediate feature maps using the teacher network.

20. The non-transitory computer-readable storage medium of claim 16, wherein the training losses comprise first losses between the first predicted feature maps and the second predicted feature maps, and second losses between the second predicted feature maps and each of the interactive feature maps; and the training losses are a sum of the first losses and all of the second losses.
